(19) United States
(12) Patent Application Publication
(10) Pub. No.: US 2009/0094108 A1
(43) Pub. Date: Apr. 9, 2009

(54) Flexible Revenue Sharing and Referral Bounty System

(76) Inventors: Atul Bhandari, Sunnyvale, CA (US); Satya Patel, Foster City, CA (US); Shirin Oskooi, Mountain View, CA (US); Christian Oestlien, San Francisco, CA (US); Aaron Lee, Mountain View, CA (US)

Correspondence Address: FISH & RICHARDSON P.C., PO BOX 1022, MINNEAPOLIS, MN, 55440-1022, US

(21) Appl. No.: 11/869,652

(22) Filed: Oct. 9, 2007

(51) Int. Cl. G06Q 30/00

(52) U.S. Cl. 705/14

(57) ABSTRACT

An advertising system manager, a partner and one or more participating publishers may collectively agree on a revenue sharing arrangement, based on revenue generated from ad conversions, for revenue sharing between publishers and partners such as content providers distributing embedded content links to publishers through the advertising system manager. The advertising system manager may define various components of the revenue sharing arrangement including details of the revenue sharing arrangement and the criteria for offering the revenue sharing arrangement. The partner may separately negotiate with the publisher with respect to the terms of the revenue sharing arrangement. The terms may include a predetermined revenue sharing rate for the partner and the publisher based on the gross revenue received by the advertising system manager.

### TECHNICAL FIELD

The subject matter of this application is generally related to online advertising.

### BACKGROUND

As the number of people using the Internet and the World Wide Web (“Web)” continues to grow, advertisers have come to appreciate and utilize online media as a potentially powerful way to advertise their products and services. One conventional approach used by advertisers to advertise products and services on the Web is to serve advertisements (“ads”) with content provided by publishers (e.g., CNN.com, ESPN.com). For example, advertisers may pay publishers when users click on ads placed on Web properties and/or purchase products and services from the advertiser as a result of such clicks. Such payments may be based on a “pay-per-click” model or some other metric or model agreed to by the advertisers and publishers. The complexities associated with managing such business arrangements have resulted in the emergence of online advertising services, such as the AdWords™ and AdSense™ programs offered by Google, Inc. (Mountain View, Calif.).

Recently, there has also been an emergence on the Web of a large number of Web properties dedicated to publishing user generated content (“UGC”), such as MySpace™, YouTube™, FaceBook™, Twitter™, Orkut™, Friendster™, weblogs (“blogs”), etc. These Web properties have become attractive targets for advertisers due to their growing popularity with certain demographics. Also, distribution of media content from content providers has been a target for advertisers.

### SUMMARY

An advertising system manager may establish a revenue sharing scheme with a network partner and/or a content partner as an incentive to sign up publishers to participate or otherwise facilitate the participation of existing publishers in one or more ad campaigns. The network partner may provide one or more hyperlinks, signs, videos, audio, games or other banners on a hosted web page to inform or encourage existing and potential publishers to participate in the one or more ad campaigns. The content partner may provide media content, either professionally or user generated, to be made available to network partners, publishers and users. The advertising system manager may define various components of the revenue sharing scheme including details of the revenue sharing scheme and the criteria for offering the revenue sharing scheme to the network partner and/or content partner. Advertisers can provide monetary incentives to the owners/operators of the Web properties (hereinafter also referred to as “partners”) to encourage partners to improve the Web properties and to grow their subscription base for the Web properties. Additionally, advertisers and partners can provide monetary incentives to users of the Web properties (hereinafter also referred to as “publishers”) to provide and improve upon UGC.

The advertising system manager, participating publisher, network partner and/or content partner also may collectively agree on a revenue sharing policy, based on the revenue generated from users viewing ads associated with one or more ad campaigns (e.g., based on conversion rates). In some implementations, the partner may directly negotiate with the publisher with respect to the terms of the revenue sharing policy, or the revenue share may be automated based on a system set up by the advertising system manager. The terms may include a predetermined revenue sharing rate for the partner and the publisher based on the gross revenue received by the advertising system manager.

In some implementations, the method of sharing revenue in an online advertising system includes: receiving input from a partner specifying a revenue sharing arrangement between the provider, one or more publishers, and the advertising system manager; receiving a request from a publisher to participate in revenue sharing with the provider; and invoking automated revenue sharing between the provider and the publisher based on the revenue sharing arrangement.

In another implementation, a method of sharing revenue in an online advertising system includes: receiving input from an advertising system manager specifying a revenue sharing arrangement between the advertising system manager, one or more publishers who publish content on a web property, and a partner; receiving a request from a publisher to participate in revenue sharing with the advertising system manager; and invoking automated revenue sharing between the advertising system manager, the partner and the publisher based on the revenue sharing arrangement.

In yet another implementations, a method of providing a referral bounty in an online advertising system includes: determining a current revenue sharing rate and a revenue threshold; disbursing revenue to be shared between a provider and a publisher who publishes on a web property hosted by the web property host based on the current revenue sharing rate; and determining a bounty based on the disbursed revenue and the revenue threshold.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram showing an example of an online advertising system.

FIG. 2 is a block diagram showing an example of a process for referring ads in the online advertising system of FIG. 1.

FIG. 3 is a flow diagram showing an example of a process for sharing revenue between a partner and a publisher in the online advertising system shown in FIG. 1.

FIG. 4 is a flow diagram showing a process for determining a bounty for a partner in the online advertising system of FIG. 1.

FIG. 5 is a schematic diagram showing an example system for implementing the features described in reference to FIGS. 1-4.

Like reference symbols in the various drawings indicate like elements.

### DETAILED DESCRIPTION

### Advertising System Overview

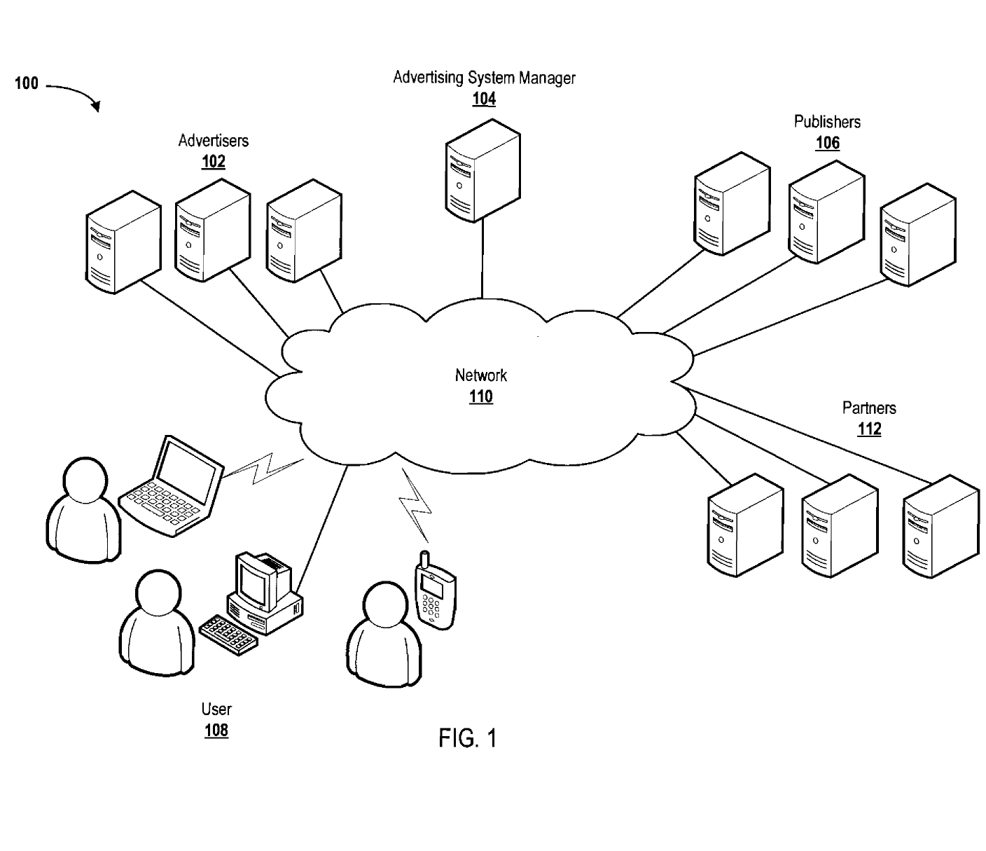

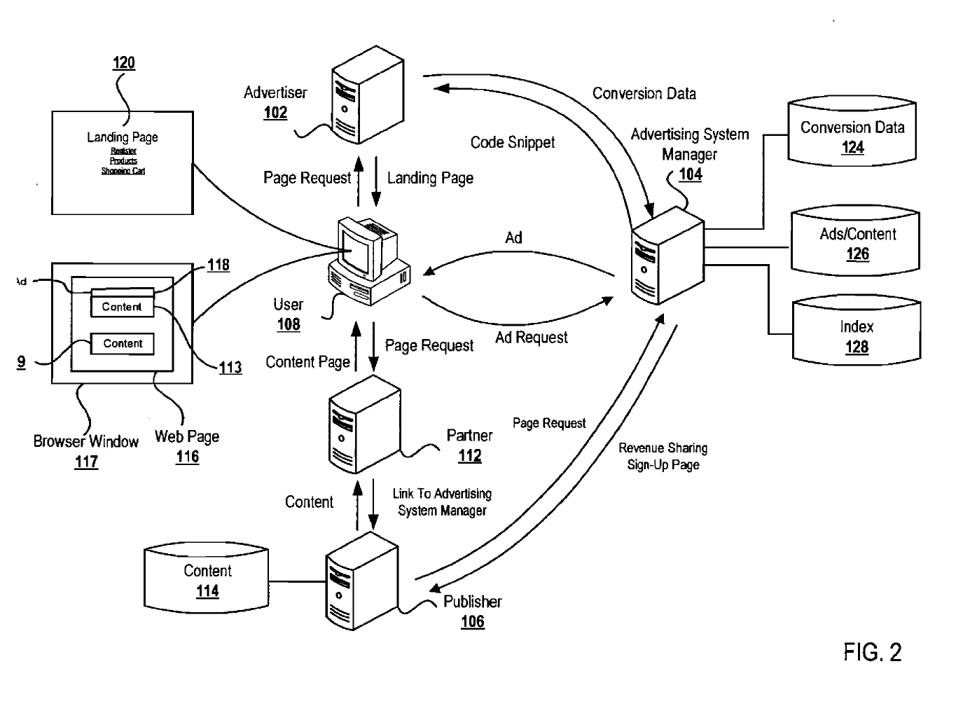

FIG. 1 is a block diagram showing an example of an online advertising system, and FIG. 2 is a block diagram showing an example of a process for referring ads in the online advertising system of FIG. 1.

Generally, the system 100 can facilitate the distribution and processing of ads. As shown, the system 100 includes one or more advertisers 102, an advertising system manager 104, one or more publishers 106, users 108, and partners 112. Each of these entities can be coupled to a network 110. The network 110 can facilitate wireless or landline communication between each entity. The network 110 may be all or a portion of an enterprise or secured network. While illustrated as a single network, the network 110 may be a continuous network logically divided into various sub-nets or virtual networks without departing from the scope of this disclosure, so long as at least a portion of the network 110 may facilitate communications of ads 118 between the advertising system manager 104, the partners 112 and the publishers 106.

In some implementations, the network 110 encompasses any internal or external network, networks, sub-network, or combination thereof operable to facilitate communications between various computing components in system 100. The network 110 may communicate, for example, Internet Protocol (IP) packets, Frame Relay frames, Asynchronous Transfer Mode (ATM) cells, voice, video, data, and other suitable information between network addresses. The network 110 may include one or more local area networks (LANs), radio access networks (RANs), metropolitan area networks (MANs), wide area networks (WANs), all or a portion of the global computer network known as the Internet, and/or any other communication system or systems at one or more locations.

### Advertiser

The advertiser 102 may establish an advertising program with the advertising system manager 104. An advertising program may include, for example, information concerning accounts, billing, campaigns, creatives, advertising formats, targeting and the like. For example, an advertiser's account may relate to information for a given advertiser such as a unique e-mail address, a password, billing information, context information and the like. A “campaign” or “ad campaign” refers to one or more groups of one or more ads, and may include a start date, an end date, budget information, geographical targeting information, and syndication information associated with the ads. For example, a fashion design manufacturer may have an advertising campaign for its clothing line, and a separate advertising campaign for its fragrance line. The campaign for its clothing line may have one or more ad groups (e.g., for different clothing types such as men and women, boys and girls and infants and toddlers), each containing one or more ads. An advertiser 102 may also be a partner 112 and/or a publisher 106.

Each ad group may include individual price information (e.g., cost, average cost, or maximum cost (per impression, per selection, per conversion, etc.)). For example, the advertiser 102 may specify a maximum monetary value with the advertising system manager 104 as to how much the advertiser 102 is willing to pay per user click or impression per ad or ad group.

Each ad group also may include targeting criteria or restrictions. Targeting criteria (or restrictions) may be used to identify the target audience for a particular ad campaign of the advertiser 102. Examples of targeting criteria may include day, geography, language, behavioral segment, demographic group, frequency cap, domain, keyword, an ad slot attribute, system information, or any other suitable characteristic of the users 108 and/or publishers 106.

The advertiser 102 can directly, or indirectly, enter, submit, maintain, and track ad 118 through the advertising system manager 104. The ad 118 may be presented on a web page 116 with content 114 authored by the publisher 106. The web page 116 can be presented in a browser window 117.

The ad 118 may be in the form of a graphical ad, such as banner ad, text only ad, image ad, audio ad, video ad, ad combining one of more of any of such components, executable code, or any other media, content, or interactive advertisement and the like. The ad 118 may also include embedded information, such as links, meta-information, and/or machine executable instructions. The ad 118 also may have various intrinsic features. Such features may be specified by an application and/or by the advertiser 102, often depending on the type of ad. For example, in the case of a text ad, ad features may include a title line, ad text, and an embedded link. In the case of an image ad, ad features may include images, text embedded links, etc.

The ad 118 may be served based on particular serving conditions or constraints. For example, the advertiser 102 may target the serving of the ad 118 by specifying that the ad 118 is to be served on weekdays, no lower than a certain position on a web page, to users in a certain geographic location and the like. As another example, the advertiser 102 may specify that the ad 118 is to be served if the content 119 with which the ad 118 is to be served contains certain keywords or phrases. As yet another example, the advertiser 102 may specify that the ad 118 is to be served if the content 119 includes particular topics or concepts, or falls under a particular cluster or clusters, or some other classification or classifications. As yet another example, a particular group of publishers 106 who reside in a particular geographic location can serve the ad 118.

In some implementations, when the user 108 clicks the ad 118, the user 108 is directed to a landing page 120 provided by the advertiser 102. The user 108 may then perform a conversion event at the website (e.g., make a purchase, register, etc.). The conversion event generates conversion data, which is sent to the advertising system manager 104 and stored in a conversion data repository 124 (e.g., MySQL® database). In this manner, a conversion history can be accumulated and maintained for each ad or ad group in an advertiser's ad campaign. A system and method for tracking conversion data may be found in, for example, U.S. Co-Pending patent application Ser. No. 10/653,899, entitled “Systems and Methods for Determining User Actions,” filed Sep. 4, 2003, the disclosure of which is incorporated herein by reference in its entirety. In other implementations, user impressions of an ad may be tracked for cost-per-mille (CPM) revenue, or user “clicks” on an ad may be tracked in a cost-per-click (CPC) revenue model.

### Advertising System Manager

In some implementations, the advertising system manager 104 can provide an online environment with user interfaces for facilitating interaction between the advertisers 102, partners 112 and publishers 106. The advertising system manager 104 may be an ad serving program run by an ad network service provider, which collaborates with the advertisers 102 to execute one or more ad campaigns. In some implementations, the publishers 106 may participate in one or more ad campaigns. In these implementations, the advertising system manager 104 may establish an incentive program with publishers interested in participating in the one or more campaigns. The incentive program may include, for example, compensating the publishers 106 in exchange for serving targeted ads on the their network properties (e.g., web pages). To increase the number of participating publishers 106, the advertising system manager 104 also may provide incentives (e.g., revenue sharing) to the partners 112 for referring publishers 106 to the ad campaigns.

The targeted ads may be administered by the advertising system manager 104, and may generate revenue on either a cost-per-click, cost-per-thousand-impressions, cost-per-action or other basis as defined by the advertiser 102 and/or advertising system manager 104. Based on the gross revenue generated from the advertisers 102, the advertising system manager 104 may determine the compensation rules, and how the gross revenue is distributed among the ad campaign participants, as will be described in greater detail below.

In some implementations, the advertising system manager 104 utilizes search technology to serve ads based on the web properties published by the publishers 106. For example, the advertising system manager 104 may search keywords and phrases in a web property to determine its type of content, and present one or more ads that are relevant to the content on the web property.

In other implementations, the advertising system manager 104 can receive and/or process ad requests from the publishers 106. The advertising system manager 104 may select appropriate ads based on, for example, an ad type requested by a publisher 106, such as banner or video ads. In addition, the advertising system manager 104 may replace an ad currently being displayed with another ad on a scheduled or random basis.

In general, the advertising system manager 104 may include applications, programs, modules, processes, or other software and hardware that can help identify the context of each publisher's web property (or receive the context from each publisher 106), and that communicates relevant ads along with other data to be presented on the web property. The advertising system manager 104 may deliver relevant text and image ads that are precisely targeted to the publishers' web properties and the content presented on those properties.

In some implementations, the advertising system manager 104 also may monitor the number of users 108 that have clicked on the ad(s) and/or records each user's subsequent action (e.g., purchasing an item, browsing through a catalog), thereby further refining context and the relevance (and placement) of each ad and ad targeting. The advertising system manager 104 may provide a management interface (not shown) to the publishers 106 (or partners 112) to help manage and keep track of advertising revenue. The management interface may allow the publishers 106 to access an associated account to retrieve data such as, without limitation, current compensation agreement established with the advertising system manager 104, revenue earned, site performance and other data analysis.

The advertising system manager 104 may be coupled to an ad/content repository 128. The advertising system manager 104 can function to receive an ad request from the publisher 106 and in response to the request, transmit and display an ad 118 (optionally with content 119) from the ad/content repository 128 to be presented in the browser window 117. The advertising system manager 104 may include an ad server (not shown) operable to receive, transmit, process and store data associated with ads. The ad server can be implemented using computers other than servers, as well as a server pool. For example, the ad server may be any computer, electronic or processing device such as, for example, a blade server, general-purpose personal computer (PC), Macintosh®, workstation, Unix-based computer, or any other suitable device. In other words, the ad server may include computers other than general purpose computers as well as computers without conventional operating systems. The ad server may be adapted to execute any operating system including Linux, UNIX, Windows® Server, or any other suitable operating system.

Generally, the ad server includes memory (e.g., cache) and a processor (not shown). Memory may be a local memory and include any memory or database module and may take the form of volatile or non-volatile memory including, without limitation, magnetic media, optical media, random access memory (RAM), read-only memory (ROM), removable media, or any other suitable local or remote memory component. The memory can function to store ad images and other electronic ads and video files. The memory may also include any other appropriate data such as VPN applications or services, firewall policies, a security or access log, print or other reporting files, HTML files or templates, data classes or object interfaces, child software applications or sub-systems, and others.

In some implementations, the advertising system manager 104 also can include a web crawler operable to crawl the web page 116. The web crawler can crawl the content repository 114 and add the content 114 to an index 128. Examples of web crawlers include open source crawlers written in Java®, such as Heritrix™, WebSPHINX™, JSpider™, WebEater™, Java Web Crawler™, WebLech™, Arachnid™, etc. The web page 116 can be crawled on a scheduled basis or in response to a trigger event, and the indexed content can be sorted and stored (e.g., in an index repository).

In some implementations, partners 112 and publishers 106 registered with the advertising system manager 104 may be able to access a secure web property to obtain information pertaining to their respective revenue shares (as will be discussed in greater detail below) using interactive web pages. Access to the advertising system manager's web property may be secure, i.e., the advertising system manager 104 may provide secure access using, for example, encryption, personal identification numbers (PINs), access codes, passwords, electronic signature authentication, security keys, and/or other similar security measures. Access to parts of another entity's account by a revenue sharer or a merchant may be limited or not allowed at all.

### Partner

A partner 112 may be an online service provider that hosts one or more web properties or other network-accessible properties that host the content 119. For example, the web page 116 can be provided by an online service that provides the publisher 106 with a personal space for sharing personal and professional content with interested users/viewers. As an example, a weblog (blog) site may provide each blogger with a personal space for authoring and publishing blogs.

The partner 112 may be, for example, a network partner such as a social network or business network. Such networks may include but are not limited to Orkut®, Myspace®, Friendster®, YouTube® and Facebook®, gaming sites, gaming networks, content sharing sites such as music and video sharing sites and the like. Other types of online networks, communities or personal web pages also may be used, such as job hunting websites (e.g., monster.com), school alumni websites, organizations of professionals, Internet dating sites, ratings sites (e.g., epinions.com), closed or proprietary networks, and company internal websites (e.g., Intranet). In some cases, partners 112 may require publishers 106 to establish a publisher account with the partners 112 in order to use one or more web properties owned by the partners 112.

A partner 112 may also be, for example, a content partner such as a source of video, music/audio, games, applications, and the like. Such content partners may be media broadcast networks, sports networks or organizations, music labels, movie studios, television production studios, specialized media content providers such as, for example, how-to or technical media providers, user-generated content directly from users or shared via a network partner such as YouTube®, Facebook®, and the like. The content partner, in one embodiment, provides media content to be embedded in a publisher's 106 web page 116 with advertisements for particular advertisers 102 served from the advertising system manager 104.

As discussed previously, the advertising system manager 104 may provide incentives to the partner 112 for referring one or more publishers to participate in one or more ad campaigns. These incentives may be in a form of a revenue sharing and a bounty bonus, as will be discussed in greater detail below.

In some implementations, a user interface (not shown) may be provided by the partner 112 for the publisher 106 for managing the web page 116. The user interface may include an administrative space, which can include various links and/or other user interface elements for allowing the publisher 106 to administer and manage web page 116. For example, the publisher 106 can create or edit an associated profile, change account settings, add/edit photos, add/change videos, manage a calendar, manage a blog, manage an address book and the like. The user interface also can include one or more areas for displaying information and content, such as an “Announcement” space for posting announcements, a “Bulletin” space for posting bulletins, a “New Message” space for displaying new emails or Instant Messages, a “Friend” space for listing members of the publisher's personal and professional network, a “New People” space for introducing new people recently added to the publisher's personal and professional network and the like. A partner 112 may also provide a user interface (not shown) to allow associated publishers 106 to manage ad settings and view ad and earnings performance reports.

When the partner 112 is a content provider, the partner 112 can provide a user interface (not shown) for the publisher 106 to embed content from the partner 112 in the publisher's 106 web property. Similarly, the advertising system manager 104 can provide a user interface (not shown) for the publisher 106 to embed content from the partner 112, or for the partner 112 to submit content for publishers 106 to make available through the advertising system manager.

In some implementations, the partner 112 can request one or more ads from the advertising system manager 104. In response to the request, one or more ads (e.g., image ads) are sent to the partner 112. The one or more ads can be presented with the content 119 on the web page 116. In some implementations, the web page 116 can have a page content identifier (ID), which can be used by the advertising system manager 104 to determine ad context for targeting ads that the user 108 will be receptive to. In these implementations, the ad context can be determined using clustering technology and geographic location data, such as, for example, the technology described in U.S. Co-Pending patent application Ser. No. 11/539,109, the disclosure of which is incorporated herein by reference in its entirety. In other implementations, the publisher 106 requests on or more ads from the advertising system manager 104, as described in more detail below.

### Publisher

Generally, the publisher 106 is a content provider that provides content 119 stored in the content repository 114 to the user 108. A publisher 106 can be a user 108 and vice-versa. The publisher 106 can add text, audio, videos and content of other format to the web page 116. In some implementations, the publisher 106 may participate in an ad campaign or campaigns by serving ads with the content 119. In these implementations, the publisher 106 and the advertiser 102 may be provided with code snippets that can be included in the web page 116 and landing page 120 for requesting ads and reporting conversion actions to the advertising system manager 104. In another implementations, the partner 112 may be provided with code snippets from the advertising system manager 104. In response, the partner 112 may insert the code snippets into the web page 116 so as to simplify the process of display ads for the publishers 106. In some embodiments, the code snippets inserted into the web page 116 provide for embedded serving of display ads for the publishers 106 along with embedded content 113 from the provider 112 to be embedded on the web page 116.

The publisher 106 also may authorize the advertising system manager 104 to select one or more ads from the ad/content repository 126 and present the one or more ads on the web page 116. In some embodiments, the publisher 106 may also authorize the advertising system manager 104 to select one or more types of embedded content 113 from partners 112 and present the embedded content 113 along with the one or more ads on the web page 116, or the publisher 106 may directly select the embedded content 113 or the partner 112 from which the embedded content 113 will be obtained. The advertisements to be displayed may be selected by a set of criteria set by the publisher 106, by the partner 112, or may be limited to advertisements matching criteria set by both the publisher 106 and the partner 112. Since the content 119 shown on the web page 116 can receive a particular degree of readership, the publisher 106 becomes part of the ad targeting process. In some implementations, each publisher 106 participating in an ad campaign needs to meet certain criteria (e.g., demographics, popularity ratings, etc.) specified by the advertiser 102, advertising system manager 104 and/or partner 112. Similarly, a partner 112 may require a publisher 106 to meet certain requirements in order to display embedded content 113.

As discussed above, the partner 112 may require the publisher 106 to establish a publisher account (e.g., a login account) with the partner 112 in order to use the embedded content 113 created by the partner 112 on the publisher's 106 web site. To obtain a publisher account, a non-registered publisher can enroll and register with a partner to acquire membership. Once registered, the non-registered publisher becomes a registered publisher, who may access an associated publisher account, and can login to the publisher account to access the embedded content 113.

The web page 116 can display both standard content 119 and one or more ads 118, along with embedded content 113 from the one or more providers 112. The ad 118 can be presented in a particular location within the web page 116, which may be referred to as an ad slot. The ad slot can have a particular height and width dimension defined by the publisher 106 or the advertiser 102. The ad 118 inserted into an ad slot can vary each time the web page 116 is served to the user 108 or, alternatively, can have a static association with the web page 116. The ad slot can be created through a snippet of code such as JavaScript, and in one embodiment, the snippet can provide a location for both the ad 118 and embedded content 113 from one or more partners 112.

In some implementations, the content 119 of the web page 116 may be a file, a combination of files, one or more files with embedded links to other files, and so forth. These files may be of any type, such as text, audio, image, video, or any other appropriate media form. Although content stored in the content repository 114 may be offline, pertinent information thereof may be available online. Such online content also may include attributes, topics, concepts, categories, keywords, relevancy information, types of ads supported, and so forth. For example, a publisher 106 may publish online content that contains information about an outdoor jazz music festival which includes the location of the concerts, the time of the concerts, artists scheduled to appear at the festival and the like. Similarly, the embedded content 113 may be a file, a combination of files, one or more files with embedded links to other files, and so forth. These files may be of any type, such as text, audio, image, video, or any other appropriate media form. Although content stored in the content repository 114 may be offline, pertinent information thereof may be available online. Such online content also may include attributes, topics, concepts, categories, keywords, relevancy information, types of ads supported, and so forth. For example, a publisher 106 may publish online content that contains information about an outdoor jazz music festival which includes the location of the concerts, the time of the concerts, artists scheduled to appear at the festival and the like.

In other implementations, content stored in the content repository 114 may include structured data containing the content (words, pictures, etc.) and some indication of the meaning of that content or metadata (for example, email fields and associated data, HTML tags and associated data, etc.). For example, the web page 116 can include content and embedded information (such as meta information, hyperlinks, etc.) and/or embedded instructions (such as JavaScript, etc.).

The publisher 106 can create or modify the web page 116 through conventional computing terminals such as a personal computer, a portable computer, a workstation, a computer terminal, a network computer, a display device (e.g., television), a mainframe, a handled device or other data processing system or user device. The publisher 106 may receive the web page 116 via the browser window 117 and by logging onto an associated publisher account. The web page 116 may be presented in a form of a personal web page, and may include additional hosted web pages that collectively describe interests, attributes or characteristics associated with the publisher 106.

In some implementations, the web page content 119 and/or embedded content 113 may include, without limitation, articles, discussion threads, music, video, games, graphics, broadcast media, search results, web page listings, information feeds and the like. The publisher 106 may submit a request for ads to the advertising system manager 104 that target the content 119 on the web page 116. In some embodiments, the publisher 106 may submit a request for embedded content 113, for which advertisements are targeted and served together. The ad request may include a number of ads desired or the type of ads to be served. The ad request may also include content request information. This information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc. In response to the publisher's ad request, the advertising system manager 104 sends the publisher 106 one or more ads for presentation on the web page 116 that can be viewed by the user 108 (e.g., a browser or other content display system), where in some embodiments the ads are sent with embedded content 113. In some instances, the publisher 106 can transmit additional information to the advertising system manager 104 or advertisers 102, including information describing how, when, and/or where the requested ad (or ads) is to be presented (e.g., in HTML, AJAX, ActiveX™ or JavaScript™). One embodiment of such an embedded content and embedded advertising display interface is shown in U.S. patent application Ser. No. 11/779,856, filed Jul. 18, 2007, entitled “Embedded Video Player,” assigned to the assignee of the present application and the disclosure of which is hereby incorporated by reference in its entirety. One embodiment of such an embedded content and embedded advertising display interface where the embedded content includes a playlist of multiple content items is found in U.S. patent application Ser. No. 11/779,832, filed Jul. 18, 2007 and entitled “Embedded Video Playlists,” assigned to the assignee of the present application and the disclosure of which I hereby incorporated by reference in its entirety.

As explained previously, when the user 108 clicks on the ad 118 displayed on the web page 116, the user 108 is redirected to a landing page 120 provided by the advertiser 102. In these implementations, when the user 108 performs a predefined conversion action, the publisher 106 may be compensated for the conversion. Generally, a conversion is a defined action in response to an ad's call to action. A conversion action can be a sale, or it could be a registration, download or entry into an advertiser's lead database, depending on the goal of the advertiser's ad campaign. Alternatively, the publisher can be compensated when a user clicks on an add in a cost-per-click (CPC) model, or per user ad impression in a cost-per-mille (CPM) model.

The user 108 and the advertiser 102, as well as the one or more publishers 106, can provide usage information to the advertising system manager 104, such as, for example, whether or not a conversion or click-through related to an ad has occurred. This usage information can include measured or observed user behavior related to ads that have been served. The advertising system manager 104 performs financial transactions, such as crediting participating publishers and charging sponsoring advertisers based on the usage information.

In some implementations, the publisher 106 receives one or more code snippets, each associated with a selected ad. Each code snippet can include a signed or encoded specification of the ad(s) determined by the publisher 106. For example, for an ad regarding MP3 music player, the publisher 106 may receive a code snippet, from the advertising system manager 104, associated with a selected ad, such as a banner ad for the MP3 music player. In some implementations, the code snippet includes a specification corresponding to the selected ad(s) that associate with a set of conversion actions (e.g., purchasing the MP3 player, subscription to a mailing list) which may result from interaction with the ad by the user 108 (e.g., a click-through). In other implementations, when ads that are eligible for a particular set of conversion actions are known by the advertising system manager 104, the specification can be omitted from the code snippet. When a conversion occurs, the conversion action allows the advertising system manager 104 to determine how much the publisher 106 is credited resulting from showing the ad 118 on the web page 116. In some embodiments, credits are accounted for based on impressions, click-through, or playback of associated embedded content 113.

In some implementations, one or more code snippets can be added to the web page codes. For example, the publisher 106 may add the banner ad code snippet to the web page codes. In some implementations, the code snippet is a web script, such as JavaScript®. The execution of the code snippet results in a contact with the advertising system manager 104 and the display of the ad 118, and in some embodiments, for embedded display of embedded content 113 as well. When the user 108 clicks on the displayed ad 118, the advertising system manager 104 is contacted again, and the user 108 is redirected to the landing page 120. During this event, the user 108 can receive a signed browser cookie from the advertising system manager 104. In some implementations, tampering with the contents of the signed browser cookie invalidates conversion actions associated with the cookie. The cookie can include information, such as an identifier of the MP3 player banner ad, an identifier of the publisher 106, and the date/time the banner ad was selected by the user 108. The cookie can then be used together with information associated with conversion actions performed at the advertiser 102 by the user 108 to credit the publisher 106 and debit the advertiser 102.

As an example, during operation, the user 108 can select a particular ad displayed on the publisher web page 116. The publisher code snippet directs the user 108 to the advertising system manager 104 from which a signed browser cookie is retrieved. In some embodiments, the selection of the ad is considered a credit towards the publisher 106 and/or the partner 112. The user 108 is then directed to the landing page 120 provided by the advertiser 102. In some embodiments, the user 108 performs a conversion action at the advertiser 102, such as purchasing a product or service, registering, joining a mailing list, etc. The advertiser code snippet can be included within a conversion confirmation page script, such as a script within a web page presented after the purchase. The advertiser code snippet contacts the advertising system manager 104 and reports the conversion type identifier from the advertiser code snippet as well as information from the cookie, such as a publisher identifier, an ad identifier, and a date/time of the ad impression and click. The conversion data (e.g., number and types of conversions) can be stored in the conversion data repository 124, where it can be used by the advertising system manager 104 to improve ad targeting performance.

### Conversion and Click-Through Overview

Generally, when a user or viewer clicks on an ad (e.g., ad 118), the embedded hypertext link associated with the ad typically directs the viewer to the advertiser's landing page. This process, wherein the viewer selects an ad, is commonly referred to as a “click-through” (“Click-through” is intended to cover any user selection). The ratio of the number of click-throughs to the number of impressions of the ad (i.e., the number of times an ad is displayed) is commonly referred to as the “click-through rate,” or CTR, of the ad. A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's web page, and consummates a purchase there before leaving that web page. Many other definitions of what constitutes a conversion are possible. The ratio of the number of conversions to the number of impressions of the ad (i.e., the number of times an ad is displayed) is commonly referred to as the conversion rate.

In some implementations, the advertising system manager 104 may receive revenue earning report for a particular product or service from the advertiser 102, and based on the revenue earning report, the advertising system manager 104 may further determine metrics such as, without limitation, click-through rates (CTR), revenue per thousand ads (RPM), conversions per dollars spent (CPD) or other suitable metrics based, at least in part, on viewer actions associated with each participating publisher.

### Revenue Sharing Process

The advertiser 102 may have an advertising program or campaign established with the advertising system manager 104. The advertising system manager 104 may facilitate the advertising campaign by identifying one or more participating publishers, and placing one or more ads on participating publishers' web properties. The advertiser 102 can be charged a fee for placement of the ads on either a cost-per-click, cost-per-thousand-impressions, cost-per-action or other basis, and the participating publishers can be credited with a portion of the fee.

In general, the fee received from the advertiser 102 is revenue. In some implementations, the advertising system manager 104 may establish a revenue sharing scheme with the partner 112 as an incentive to sign up additional publishers to participate or otherwise facilitate the participation of existing publishers in one or more ad campaigns. For example, the advertising system manager 104 may distribute 50% of the gross revenue to the partner 112 while retaining the remaining 50% of the gross revenue. In another implementations, the revenue sharing scheme also may include the publisher 106, as will be described in greater detail below.

The partner 112 may provide one or more pieces of embeddable content 113, hyperlinks, signs or banners on the web page 116, or directly through the partner's 112 web presence, to inform or encourage existing and potential publishers to participate in the one or more ad campaigns. In implementations in which hyperlinks are provided, the hyperlinks can direct potential publishers to a web page provided by the advertising system manager 104. The web page may provide directions, rules, policies or instructions as to how a user may participate in an ad campaign. The web page also may provide a user interface through which a user may establish a publisher account to become a publisher and participate in the ad campaign, and in particular, revenue sharing with the advertiser 102 and partner 112.

The partner 112 also may increase its network of participating publishers 106 by publicizing and offering potential publishers, for example, embeddable content 113 for inclusion on the publisher's web page 116, free web hosting, free email accounts, free or discounted premium access to publishing tools that are not normally accessible to non-participating publishers. In some implementations, the advertising system manager 104 may collect a separate fee from the advertiser 102 for managing the placement of the ads and targeting ads based on the publisher content.

The advertising system manager 104 may define various components of the revenue sharing scheme including details of the revenue sharing scheme and the criteria for offering the revenue sharing scheme to the partner 112. Details of the revenue sharing scheme may include, for example, information describing the nature and quantitative measure of the compensation being offered, and the criteria may include, for example, publishers 106 who publish a particular type of content or publishers 106 that reside in a particular geographic location.

The advertising system manager 104, the participating publisher 106 and the partner 112 also may collectively agree on a revenue sharing policy, based on the revenue generated from the users 108 viewing the ads (e.g., based on impressions, click-through, or conversion rates). In some implementations, the partner 112 may directly negotiate with the publisher 106 with respect to the terms of the revenue sharing policy. The terms may include a predetermined revenue sharing rate for the partner 112 and the publisher 106 based on the gross revenue received by the advertising system manager 104. For example, if the gross revenue received from the advertising system manager 104 is $100 and 40% of which is retained for covering operational cost, a partner may incentivize a publisher 106 to participate in an ad campaign by allocating 85% of the remaining 60% of the gross revenue to the publisher 106 as profit. The terms may be modified at any period to reflect a higher or lesser revenue sharing rate. Using the example given above, the terms may be modified after 30 days by the partner 112 to allocate 95% (as opposed to 85%) of the remaining 60% of the gross revenue to the publisher 106.

In some implementations, a partner 112 may offer different revenue sharing levels (e.g., tiered levels) to participating publishers based on the quality of publisher content, popularity of associated web page (e.g., based on a number of user visits) or class of membership (e.g., Gold, Silver or Bronze that a participating publisher has enrolled with a partner). For example, participating publishers with Gold memberships may receive a revenue sharing rate of 60%, participating publishers with Silver memberships may receive a revenue sharing rate of 50%, and participating publishers with Gold memberships may receive a revenue sharing rate of 40%. As another example, a participating publisher with the most user visits may receive a revenue sharing rate of 80%, while other participating publishers receive a revenue sharing rate of 50%.

Of course, the revenue allotted to the partner 112 and the publisher 106 need not be made a percentage of the gross revenue. Rather, the partner 112 may receive a flat fee from the advertising system manager 104 for each publisher referral, or the publisher 106 may receive a flat fee from the advertising system manager 104 for each ad presented or each click-through. The partner 112 may also receive a portion of the revenue generated from cost-per-click, cost-per-action or cost-per-impression conversion as a result of the publisher's participation in an ad campaign running on the web page 116. In one embodiment, the partner 112 revenue share is further subdivided between the partner 112 and further third party creators and licesors of embedded content 113 provided by the partner 112.

In instances where the partner 112 has association with multiple participating publishers 106, the partner 112 may receive a percentage of revenue share from each publisher 106 according to the respective terms. The terms may be extended to existing and potential publishers 106. The revenue sharing policy may be specified on a per partner-publisher pair basis. Alternatively, the same revenue sharing policy may apply to all associated participating publishers 106. As an example, if a partner 112 has three participating publishers 106 (e.g., publisher “A”, publisher “B” and publisher “C”), and the partner 112 has negotiated a 15% revenue sharing rate with publisher “A”, then the partner 112 also would receive the same revenue sharing rate from publisher “B” and publisher “C”.

In implementations in which the partner 112 receives a 15% revenue sharing rate from publisher “A” but declares a different revenue sharing rate with publisher “B” and publisher “C,” the advertising system manager 104 can intervene to automatically adjust the revenue sharing rate with publisher “B” and publisher “C,” so that the revenue sharing rate is identical with each publisher. In some implementations, the advertising system manager 104 may track potential rate inconsistency based on payable events including cost-per-impression, cost-per-click and cost-per-action events, and intervene by adjusting the revenue payout to the partner 112 so as to match the revenue rate specified with publisher “B” and publisher “C”. Alternatively, the advertising system manager 104 may notify the partner 112 and request a change be made until the revenue sharing scheme can become effective.

In other instances, even if the revenue sharing rate specified between the partner 112 and each participating publisher 106 is consistent, the partner 112 can unfairly manipulate the revenue sharing scheme by, for example, using the publisher content 119 as means to draw potential users, and dynamically switching out ads 118 shown on the web page 116 with ads associated with another ad campaign in which the partner 112 may personally participate, thus reducing the percentage of gross revenue that the publisher 106 could have received from the ad campaign in which the publisher 106 partakes.

More specifically and as discussed above, ads may be shown on the web page 116 by inserting a code snippet with the content 119. This code snippet generally contains a publisher identification that determines the identity of the publisher 106, and identifies which publisher 106 should receive the revenue and impressions/click/conversions credit for the ads displayed on the web page 119. Typically, this publisher identification is that of the publisher 106 that owns and authors the content 119 on the web page 116. In a two-way revenue sharing scheme where the advertising system manager 104 and the publisher 106 may have agreed to a revenue sharing rate, the advertising system manager 104 can credit a proper publisher (as opposed to a different publisher) by referring to the publisher identification. In a three-way revenue sharing scheme involving the advertising system manager 104, the publisher 106 and the partner 112, the partner 112 receives credit from the advertising system manager 104 and forwards a portion of the credit to the publisher 106 based on the publisher identification (e.g., as identified by the advertising system manager). However, since the partner 112 is placing the code snippet on the web page 119 hosted by the partner 112, the partner 112 has the ability to replace the publisher identification with that of the partner's personal publisher identification. For example, the partner 112 may show own ads with his own publication identification 20% of the time to receive 20% more revenue than that the publisher 106 would otherwise receive. This is referred to as ad code rotation, which enables callous partners to accrue revenue for monetizing the content 119 instead of the publishers.

Thus, in some implementations, the advertising system manager 104 may systematically determine the origination of each ad against publisher content on a scheduled or random basis, identify ads that are not associated with an ad campaign participated by the publisher 106, and notify the publisher accordingly. The advertising system manager 106 also can track potential ad code rotation by checking on a scheduled or random basis if more than one publisher identification appears in the code snippet at two different instances of time for the same web page (e.g., web page 116). If the advertising system manager 106 determines that more than one publisher identification appears in the code snippet on a web page at two different instances of time, then the partner associated with the web page may be sanctioned or penalized.

The advertising system manager 104 may implement a fee policy in which a portion of the gross revenue to be retained by the advertising system manager 104 is taken out prior to disbursing the gross revenue to the partner 112 for distribution to the publisher 106. As an example, if the gross revenue generated from an ad campaign is $100 and the revenue sharing rate for the advertising system manager 104, partner 112 and the publisher 106 is 40%, 15% and 85% respectively, then the advertising system manager 104 may retain $40 before disbursing the remaining revenue of $60 to the partner 112, which would receive $9, and to the publisher 106, which would receive $51.

Other orders also are possible. For example, the advertising system manager 104 may first disburse the gross revenue to the partner 112 and the publisher 106 in accordance with the revenue share agreement between the partner 112 and the publisher 106 prior to retaining the revenue share allotted to the advertising system manager 104. The advertising system manager 104 may subsequently deduct and retain a percentage of revenue from the portion disbursed to the partner 112 and a percentage of revenue from the portion disbursed to the publisher 106.

In some implementations, the advertising system manager 104 may deduct a different percentage of revenue from the partner 112 and the publisher 106. For example, if the gross revenue generated from an ad campaign is $100 and the revenue sharing rate for the partner and the publisher is 15% and 85% respectively, the advertising system manager 104 may disburse $15 to the partner and $85 to the publisher. Then, the advertising system manager 104 may deduct 30% of the $15 (i.e., $4.50) disbursed to the partner 112, and 40% of the $85 (i.e., $34) disbursed to the publisher 106 to cover operational cost. This variable rate allows the advertising system manager 104 to further incentivize and encourage the continuous participation of partners 112 or publishers 106 that are valuable to the ad campaign and revenue generation. For example, the partner 112 may have a large group of associated publishers each participating in the ad campaign. In this example, the advertising system manager 104 may reduce the percentage of revenue collected from the partner 112 (e.g., from 30% to 20%), so that a larger percentage of revenue can directly pass onto the partner 112 as a reward for the partner's performance, while maintaining the percentage of revenue collected from each of the publishers 106.

Similarly, the advertising system manager 104 may reduce the percentage of gross revenue collected from a participating publisher 106 (e.g., from 40% to 30% for a top performer) while maintaining the percentage of revenue collected from a partner 112, so that a larger percentage of revenue can directly pass onto the publisher 106 as a reward for its increase in content readership and improved content.

The advertising system manager 104 may track financial, contractual, service and auditing issues on behalf of the advertiser 102, the partner 112 and the publisher 106. For example, the advertising system manager 104 may be primarily responsible for debiting the advertisers 102, receiving payments from the advertisers 102, determining a gross revenue, crediting the partners 112 and/or publishers 106 in accordance with the revenue sharing rates specified in the existing revenue sharing agreements. The partner 112 may be responsible for splitting a portion of the revenue received from the advertising system manager 104 with the publisher 106 according to the terms arranged between the partner 112 and the publisher 106.

In another implementations, the publisher 106 and the advertising system manager 104 may agree on a revenue sharing arrangement without the participation of the partner 112. For example, the publisher 106 may directly negotiate a revenue sharing rate with the advertising system manager 104 for participating in an ad campaign. In these implementations, the publisher 106 may sign up with the advertising system manager 104 to become a partner 112, and to host other publishers 106 or to provide its own embeddable content 113 to other publishers 106. In such implementations, the partner 112 may receive a variable or flat fee (or rate) from the publisher 106 for managing the display of ads and/or embeddable content 113 on the web page 116.

Partners 112, in one implementation, may be capped at a maximum revenue sharing rate by the advertising system manager 104, so as to discourage the partners 112 from taking all or a dominant portion of the revenue from content monetization of the publishers' network properties. For example, each partner 112 may be capped a maximum revenue sharing rate of 75% by the advertising system manager 104 to prevent revenue abuse. In another implementation, other incentives may be applied, so as to allow the possibility of passing all of the gross revenue directly to the publishers 106, which can potentially encourage the improvement of content to obtain a higher rate of readership.

In some implementations, a partner 112 may modify terms of an existing revenue sharing agreement. As an example, a partner 112 may decide to modify a revenue sharing rate with associated publishers 106. The partner 112 may submit a change of revenue sharing rate to the advertising system manager 104 for confirmation. The change may be submitted through a user interface configured to facilitate communication between the partners 112 and the advertising system manager 104. Alternatively, the change may be submitted in the form of an electronic mail or message outside the user interface.

In response to receiving a request to change a revenue sharing rate, the advertising system manager 104 may notify each associated publisher 106 regarding the rate change request. For example, the advertising system manager 104 may notify all associated publishers 106 through electronic messaging (or associated account with the advertising system manager 104) that a revenue sharing rate for a corresponding partner 112 will be adjusted from “15%” to “20%”. In another implementations, the partner 112 may be required to directly notify all participating publishers 106 associated with the partner 112 of the modified terms.

In some implementations, the rate change becomes effective only after a predetermined period so as to allow the participating publishers 106 an opportunity to abide and adapt to the new rate change. As an example, the modified terms of the existing revenue sharing agreement becomes effective after thirty days from the time of receiving the request. As another example, the modified terms of the existing revenue sharing agreement becomes effective after thirty days beginning from the day the new rate change is communicated to the participating publishers 106.

In response to the rate change request, a publisher 106 may be given an option to accept the new modified terms or alternatively, associate with a new partner 112 that has a lesser partner revenue sharing rate.

In some implementations, the terms of a revenue sharing agreement may be determined prior to forming the association between the prospective publisher 106 and associated partner 112. For example, during the partner-publisher association process, each prospective publisher 106 may evaluate the association with the partner 112. The evaluation may be based on the revenue sharing rate the partner 112 has established with other participating publishers 106. Each prospective publisher 106 may compare the revenue sharing rate between partners 112 prior to forming an association with a partner 112. In some implementations, if a partner 112 has submitted a rate change request that has yet to become effective, the prospective publisher 106 can be notified about the new rate change and the value related to the change.

When a partner 112 with multiple participating publishers 106 submits frequent requests to change terms of an existing revenue sharing agreement, the frequent changes may lead to confusion among the participating publishers 106. Thus, in some implementations, the number of requests that the partner 112 can submit to the advertising system manager 104 may be limited. For example, the advertising system manager 104 may permit only one request per month. In another implementations, the advertising system manager 104 may impose a probation period between requests. For example, the probation period may be ninety days between a previous request and a current request.

While the aforementioned implementations are described in terms of a publisher 106 being associated with a single partner 112, the publisher 112 also may form association with multiple partners 112. For example, publisher “A” may set up a blog on “blogger.com” and participate in revenue sharing scheme with “blogger.com” by enabling one or more ads to be shown on the blog. Concurrently, publisher “A” also may have a personal web space on “Myspace.com” where publisher “A” may establish a personal profile page that describes interests, attributes, characteristics, networks and organizations associated with publisher “A”. Publisher “A” may participate in a different revenue sharing scheme with “Myspace.com” by enabling contextual ads to be shown in the personal profile page for viewers browsing the page. Similarly, a publisher 106 may embed content from multiple partners 112 with associated advertisements.

In some embodiments, the partner 112 may exclude come content 113 from being used in revenue sharing, and/or the publisher 106 may exclude certain partners 112 or content 113 from appearing on the publisher 106 web site 116. The embedded content 113 may be a single piece of content or may be a playlist of content that can be played in an ordered format.

### Bounty Referral Program

In some implementations, the advertising system manager 104 also may implement a bounty referral program that awards partners 112 for signing up new publishers 106 to participate in one or more ad campaigns managed by the advertising system manager 104. The bounty program may be structured to be more favorable to partners 112 who allocate a greater portion of their received revenue to participating publishers 106. Offering a higher revenue share to participating publishers 106 may encourage more publishers to publish their content on partner web properties, while also promoting publisher loyalty among participating publishers by providing adequate compensation for publishing.

The bounty referral program may offer a bounty bonus that may be calculated based on the revenue share allocated to each participating publisher 106 after adjusting for the partner's revenue share. The bounty bonus also may be determined based on the gross revenue prior to revenue deduction allotted to the advertising system manager 104 for ad campaigns administered on the web page 116.

In some implementations, there may be a revenue threshold and a time limit during which the revenue threshold must be reached by the publisher 106 in order that the partner 112 be qualified to receive a bounty bonus. For example, if the revenue threshold is set at $10 and the time limit is set at a period of 180 days, then partner “A” will be eligible to receive a bounty bonus only when publisher “A” gains $10 in revenue within 180 days.

In some implementations, if a publisher 106 is associated with multiple partners 112, then the revenue threshold (and time limit) may be specified with respect to a particular partner. As an example, if publisher “A” is associated with both partner A and partner B and assuming that the revenue threshold and time limit for partner “A” and partner “B” are respectively set at $10 within 180 days and $20 within 90 days, then partner A may be eligible for a bounty bonus only if publisher “A” gains $10 in earnings on a web page hosted by partner “A” within 180 days, and partner “B” may be eligible for a bounty bonus only if publisher “A” gains $20 in earnings on a web page hosted by partner “B” within 90 days.

In some implementations, the bounty referral program may be established as a function of the shared revenue, the revenue sharing rate and a predetermined revenue threshold. A bounty bonus may be awarded to a partner 112 when a revenue of a participating publisher 106 has reached a predetermined threshold. In some implementation, the amount of the bounty bonus to be disbursed to the partner 112 is equal to the predetermined revenue threshold. For example, if the predetermined revenue threshold is set at $10, then the partner 112 would receive a bounty bonus of $10 when the publisher 112 revenue reaches $10.

A bounty bonus may be applied every time a predetermined revenue threshold is reached. For example, if a participating publisher 106 has a revenue of $30 where the predetermined revenue threshold is set at $10, then the associated partner 112 would receive a bounty bonus of $30 (3*$10 for every $10 reached) under the bounty referral program in addition to the revenue received under the revenue sharing agreement.

As an example, given partner “A” and publisher “A” referred by partner “A” who have respectively agreed to a 25% and 75% revenue sharing rate, and partner “B” and publisher “B” referred by partner “B” who have respectively agreed to a 50% and 50% revenue sharing rate, and assuming that a portion of the gross revenue that remained daily after the adjustment of the advertising system manager's revenue share (i.e., the net revenue) is $1, under the condition of the revenue sharing agreement, in 10 days, publisher “A” would receive $7.50 ($1*10 days*75% revenue sharing rate), and publisher “B” would receive $5.00 ($1*10 days*50% revenue sharing rate). If the predetermined revenue threshold is set at $10, then partner “A” who refers publisher “A” to the ad campaign would receive a profit of $2.50 (e.g., $1*10 days*25% revenue sharing rate) under the revenue sharing agreement, but would not receive a bounty bonus because the revenue received by publisher “A” did not reach the predetermined revenue threshold (i.e., $10). Similarly, partner “B” who refers publisher “B” to the ad campaign would only receive a profit of $5.00 (e.g., $1*10 days*50% revenue sharing rate) under the revenue sharing agreement, but would not receive a bounty bonus because the revenue received by publisher “B” did not reach the predetermined revenue threshold of $10.

However, using the same criteria applied in the previous example, in fifteen days, publisher “A” would receive $11.25 ($1*15 days*75% revenue sharing rate), while publisher “B” would receive $7.50 ($1*15 days*50% revenue sharing rate). Because the revenue of publisher “A” exceeded the required revenue threshold of $10, which qualifies partner “A” to receive a bounty bonus, partner “A” would receive $13.75 of which $3.75 ($1*15 days*25% revenue sharing rate) is the revenue received under the revenue sharing agreement, and $10 is the revenue received under the bounty referral program. On the other hand, because the revenue received by publisher “B” did not reach the predetermined revenue threshold of $10, partner “B” is not eligible to receive a bounty bonus.

As is apparent from the above examples, partner “A” initially has a revenue less than partner “B” (e.g., in 10 days). However, with the implementation of the bounty referral program, a partner 112 with a lower revenue sharing rate (e.g., 25%) may benefit from a greater revenue earning power than a partner 112 with a higher revenue sharing rate (e.g., 50%) in the longer terms (e.g., $13.75 in 15 days and $40 in 40 days for partner “A” compared to $7.50 in 15 days and $30 in 40 days for partner “B”).

With the bounty referral program, allocating a high revenue sharing rate to each participating publisher 106 may allow a partner 112 to financially benefit from receiving a greater revenue in the long term, while attracting prospective publishers 106 and promoting publisher loyalty. The bounty referral program allows a partner 112 to allocate a greater share of revenue to participating publishers 106 without suffering from diminished revenue, allowing the partner 112 to flexibly structure a revenue scheme that fits a particular business profile.

As an example, if a partner's business model to allow publishers to participate in an ad campaign through the advertising system manager is to increase business revenue, then the partner may choose to allocate a low percentage of revenue to participating publishers. As another example, if a partner's business model is to draw and attract publishers that generate quality content, then the partner may flexibly keep little or no revenue share from the participating publishers.

In some implementations there may be more than one bounty threshold with corresponding bounty bonuses defined under each threshold. This creates a tiered bounty structure. For example, in a first tier, a partner may become eligible for a bounty bonus of $10 if a participating publisher gains $10 in revenue. In a second tier, the partner may become eligible for a bounty bonus of $250 if a publisher gains $100 in revenue, thus accumulating a total of $255 in bounty bonus for the partner based on the tiered bounty structure.

In some implementation, a partner may also be rewarded for enrolling a number of publishers that reach one or more revenue thresholds as described above. For example, assuming that the revenue threshold is set at $100 and if twenty five participating publishers have gained $100 in net revenue (e.g., after adjusting for the portion of revenue share retained by the advertising system manager), then the partner may be qualified to receive an additional bounty bonus (e.g., a bounty bonus of $2000). There may be a limit on the number of such bonuses that can be issued to a partner in a given time period. For example, the additional bounty bonus based on the number of participating publishers who have reached a particular revenue threshold may be limited to one per year. Alternatively, there is no limit as to the number of such bonuses that can be issued to a partner in a given time period.

### Exemplary Processes

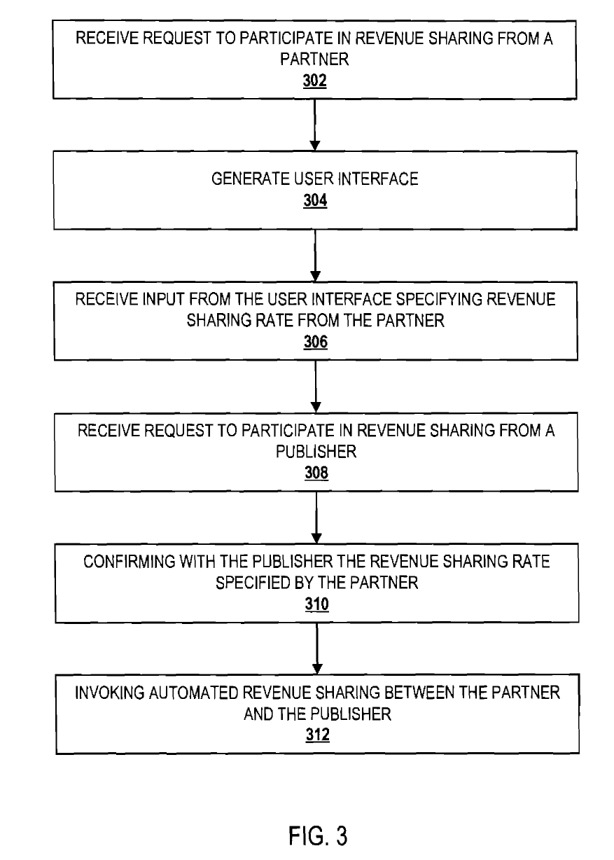

FIG. 3 is a flow diagram of an exemplary process for determining revenue sharing between a partner 112 and a publisher 106. The process 300 may be performed, for example, by the system 100, and for clarity of presentation, the description that follows uses these as the basis of examples for describing the process 300. However, another system, or combination of systems, may be used to perform the process 300.

In the example shown, the process 300 begins with receiving a request to participate in revenue sharing from a partner (302). A partner may be an online service provider that hosts one or more web properties, or may be a source of online content that can be embedded along with advertisements to be provided to publishers. A web property can be, for example, an online service which provides a publisher with a personal space for sharing user generated content with interested users/viewers, a media company, a music label, a broadcast network, and the like.

In response to the request, a graphical user interface (GUI) may be generated (304). The GUI may be operable to allow the partner to interface with at least an advertising system manager for any suitable purpose, such as viewing advertisements. Generally, a GUI provides the particular user with an efficient and user-friendly presentation of data provided by or communicated within system 100. The GUI may comprise a plurality of customizable frames or views having interactive fields, pull-down lists, and buttons. In some implementations, if the partner has previously participated in the revenue sharing scheme, the GUI may be operable to display past revenue sharing rates in a user-friendly form. The GUI may also present a plurality of portals or dashboards.

The GUI can be configurable, supporting a combination of tables and graphs (bar, line, pie, status dials, etc.), and may be able to build real-time data, including current revenue obtained, current revenue rate and the like. It should be understood that the term graphical user interface may be used in the singular or in the plural to describe one or more graphical user interfaces and each of the displays of a particular graphical user interface. Indeed, reference to a GUI may indicate a reference to a front-end as well as the particular interface accessible via the advertisers, partners or publishers, as appropriate. Therefore, the GUI as discussed herein contemplates any graphical user interface, such as a generic web browser or touch screen, that processes information in system 100 and efficiently presents the results to the user.

In some implementations, if the partner is already participating in the revenue sharing scheme, then operation 302 may be omitted, and the partner may login (e.g., via username and password) to access the user interface. The login may occur, for example, via a web page and the login process may use encryption, such as secure Hypertext Transfer Protocol (HTTPS).

The process 300 also includes receiving input from the partner specifying a revenue sharing rate (306). For example, a partner may specify a revenue sharing rate of 50%, in which the partner would receive 50% of the gross revenue, or 50% of the remaining revenue after deducting operating expenses (e.g., operated expenses incurred by the advertising system manager). In some implementations, receiving input from the partner specifying a revenue sharing rate may include modifying the previous revenue sharing rate.

The process 300 proceeds with receiving a request from a publisher associated with the partner to participate in the revenue sharing scheme (308). The publisher may be a content provider that provides content to viewers/users through a web property hosted by the partner, or it may be a publisher that wishes to embed content from the provider on the publisher's own web property. In some implementations, receiving a request from a publisher includes receiving a request from the publisher through a partner's web property. For example, the publisher may click on a hyperlink displayed on the web property provided by the partner, which may direct the publisher to a web page provided by the advertising system manager. The publisher may then establish an account to participate in the revenue sharing scheme.

The process 300 then confirms the revenue sharing rate specified by the partner with the publisher (310). In some implementations, confirming the revenue sharing rate may include displaying revenue sharing rates of other partners, so as to allow the publisher to compare rates between various participating partners. In other implementations, confirming the revenue sharing rate may include receiving additional information from the publisher associated with, for example, the type of content that the publisher provides to the viewers/users. The publisher may also be provided with a user interface where the publisher can, at any time, log in and view the revenue share rate set by various partners with whom the publisher is associated.

Next, the process 300 invokes automated revenue sharing between the partner and the publisher (312). In some implementations, invoking automated revenue sharing may include determining when a previous revenue sharing rate, if any, had taken effect. If the previous revenue sharing rate had taken effect less than a desired period of time, then invoking automated revenue sharing may include invoking the revenue sharing after the desired period is exceeded. As an example, if the desired period is 90 days and the current revenue sharing rate was last modified 30 days ago, then process 300 would only invoke the automated revenue sharing after 60 days.

In another implementations, invoking automated revenue sharing may include determining the frequency at which the revenue sharing rate is modified in a given period. In these implementations, if the frequency in a given period exceeds a predetermined ratio, then invoking automated revenue sharing may include invoking the revenue sharing only after the given period has expired. For example, if the predetermined ratio is modified twice in 30 days, and it is determined that the current proposed modification to the revenue sharing rate is the third modification in 15 days, then process 300 would invoke the automated revenue sharing after 15 days.

Operations 302-312 in process 300 may be performed in the order listed, in parallel (e.g., by the same or a different process, substantially or otherwise non-serially), or in reverse order. For example, in some implementations, receiving a request to participate in revenue sharing from a publisher (308) may be performed prior to receiving input from a partner specifying revenue sharing rate (306). In other implementations, receiving a request to participate in revenue sharing from a publisher (308) may be performed prior to receiving a request from a partner to participate in revenue sharing (302).

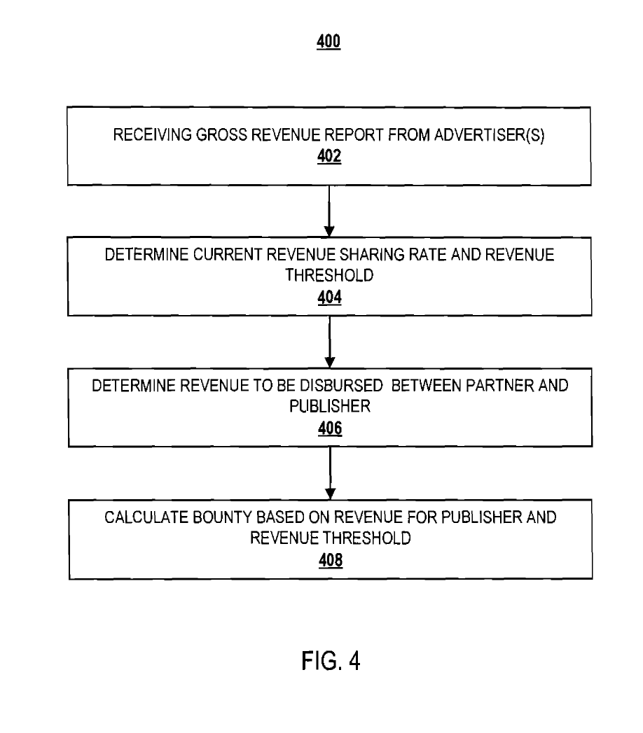

FIG. 4 is a flow diagram of an exemplary process 400 for determining a bounty for a partner. Similar to process 300, the process 400 may be performed, for example, by the system 100, and for clarity of presentation, the description that follows uses these as the basis of examples for describing the process 400. However, another system, or combination of systems, may be used to perform the process 400.

As shown, the process 400 begins with receiving gross revenue report from advertiser(s) (402). In some implementations, the gross revenue report may include information including but not limited to: click-through rates, revenue per thousand ads, conversions per dollars spent and other conversion data associated with transactions related to served ad(s), etc. In some implementations, the advertising system manager may be able to generate such a report based upon data that flows through the online advertising system.

The process 400 may include determining the current revenue sharing rate and a revenue threshold (404). In some implementations, the process may determine the current revenue sharing rate between a partner and a publisher based on input received in process 300 (e.g., from operation 306). The revenue threshold may be defined, for example, by the advertising system manager 104. A bounty may be distributed to the partner when the publisher's earning has reached the revenue threshold.

In some implementations, the revenue threshold is determined based on the revenue sharing rate. The revenue threshold can be established proportionally with the revenue sharing rate specified by the partner. As an example, lowering the revenue sharing rate distributed to the partner (e.g., from 20% to 10%) would lower the revenue threshold (e.g., from $20 to $10), allowing the publisher to reach the revenue threshold in a shorter period.

The process 400 further includes determining revenue to be disbursed between the partner and the publisher (406) and calculating (e.g., automatically) a bounty based on the revenue sharing rate and the revenue threshold (408). In some implementations, the bounty is calculated from the publisher revenue after adjusting for the partner's revenue share. In these implementations, calculating a bounty may include comparing the publisher revenue against the predetermined revenue threshold. If it is determined that the publisher revenue is less than the predetermined revenue threshold, then a bounty will not be distributed to the partner. For example, if the net revenue is $10, the revenue threshold is set at $20, and the revenue sharing rate between the partner and the publisher is set at a ratio of 90% to 10%, then the partner would not be qualified to receive a bounty, because the publisher revenue of $10 did not exceed the revenue threshold. As another example, using the same criteria with the exception that the revenue sharing rate between the partner and the publisher is set at a ratio of 20% to 80%, then the partner would be eligible to receive a bounty, because the publisher revenue of $80 exceeded the revenue threshold.

In some implementations, the bounty is calculated based on the gross revenue before operation costs are deducted. Exemplary operation costs may include, without limitation, the revenue share to be disbursed to the advertising system manager. In these implementations, the revenue threshold is compared against the remaining revenue share after adjusting for the partner's revenue share and the operation cost. As an example, if the gross revenue is $100, the revenue sharing rate between the partner and the publisher is set at a ratio of 60% to 40% (i.e., the publisher would receive $40) and the operation cost is $20, then the remaining $20 (i.e., subtracting the operation cost from the publisher revenue) is compared against the revenue threshold. A bounty bonus may then be subsequently awarded to the partner when the remaining revenue share (after adjusting for the partner's revenue share and the operation cost) has met the predetermined revenue threshold.

### Generic Computer System

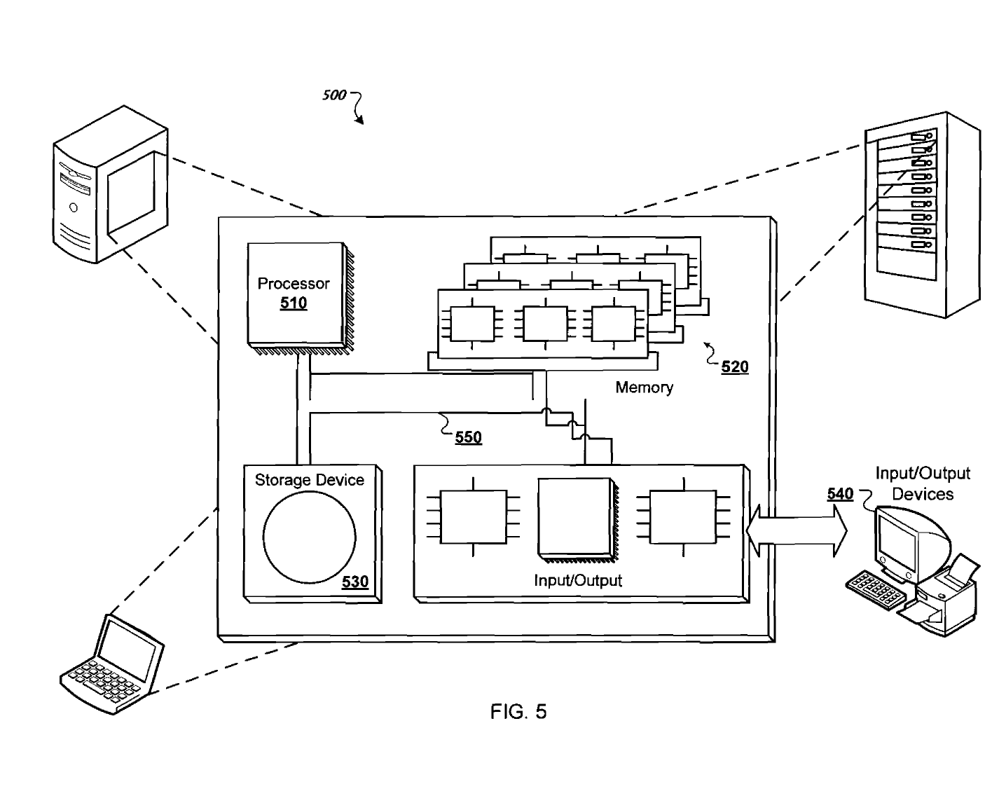

FIG. 5 is a schematic diagram of an example of a generic computer system 500. The system 500 can be used for the operations described in association with the method 300 according to one implementation. For example, the system 500 may be included in devices or systems owned or operated by any of the advertisers 102, the advertising system manager 104, and the publishers 106.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In some implementations, the processor 510 is a single-threaded processor. In another implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In another implementations, the memory 520 is a volatile memory unit. In yet another implementations, the memory 520 is a non-volatile memory unit.

The storage device 530 is capable of providing mass storage for the system 500. In some implementations, the storage device 530 is a computer-readable medium. In various different implementations, the storage device 530 may be a floppy disk device, a hard disk device, an optical disk device, or a tape device.

The input/output device 540 provides input/output operations for the system 500. In some implementations, the input/output device 540 includes a keyboard and/or pointing device. In another implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method of sharing revenue in an online advertising system, comprising:
receiving input from a content partner specifying a revenue sharing arrangement between the content partner and one or more publishers through an advertising manager system;
receiving a request from a publisher to participate in revenue sharing with the content provider through the advertising manager system; and
invoking automated revenue sharing between the content provider, the publisher, and the advertising manager system based on the revenue sharing arrangement.

2. The method of claim 1, wherein receiving input from the content partner specifying a revenue sharing arrangement between the partner, the one or more publishers and an advertising manager includes:
specifying a revenue sharing rate between the partner and the advertising manager;
specifying a revenue sharing rate between the one or more publishers and the advertising manager; and
specifying a revenue sharing rate between the partner and the one or more publishers.

3. The method of claim 1, further comprising:
embedding content from the partner on a web property by the publisher,
wherein invoking automated revenue sharing between the partner and the publisher includes serving advertisements from the advertising manager to the publisher with the embedded content.

4. A system comprising:
a processor;
a computer-readable medium operatively coupled to the processor and including instructions, which, when executed by the processor, causes the processor to perform operations comprising:
receiving input from a partner specifying a revenue sharing arrangement between the partner and one or more publishers who publish on a web property at an advertising manager;
receiving a request from a publisher to participate in revenue sharing with the partner through the advertising manager; and
invoking automated revenue sharing between the partner, the advertising manager and the publisher based on the revenue sharing arrangement.

5. The system of claim 4, wherein the request from a publisher to participate in revenue sharing further includes a request for embedded content from the partner.

6. The system of claim 4, further including an embedding link provided from the advertising manager to the publisher for embedding the content from the partner and the advertisements from the advertising manager on the web property of the publisher.

7. A computer-readable medium having instructions stored thereon, which, when executed by a processor, causes the processor to perform operations comprising:
receiving input from an advertising system manager specifying a revenue sharing arrangement between the advertising system manager and one or more publishers who publish user generated content on a web property hosted by a web property host;
receiving a request from a publisher to participate in revenue sharing with the advertising system manager including a request for at least one piece of embedded content from a partner of the advertising manager; and
invoking automated revenue sharing between the advertising system manager and the publisher based on the revenue sharing between the advertising system manager, the publisher, and the partner.

8. The computer-readable medium of claim 7, wherein the request for at least one piece of embedded content includes a request for a playlist of material related to at least one topic.

9. The computer readable medium of claim 7, wherein the invoking step and the receiving step are performed without requiring any further action by the partner.
